(19) United States
(12) Patent Application Publication
(10) Pub. No.: US 2022/0255386 A1
(43) Pub. Date: Aug. 11, 2022

(54) COIL, STATOR, AND MOTOR

(71) Applicant: Komatsu Ltd., Tokyo (JP)

(72) Inventors: Hiroki Hijikata, Tokyo (JP); Natsuki Watanabe, Tokyo (JP); Teiichirou Chiba, Tokyo (JP)

(73) Assignee: Komatsu Ltd., Tokyo (JP)

(21) Appl. No.: 17/626,875

(22) PCT Filed: Aug. 24, 2020
(86) PCT No.: PCT/JP2020/031756

§ 371 Date: Jan. 13, 2022

(30) Foreign Application Priority Data
Aug. 29, 2019 (JP) 2019-157090

(51) Int. Cl. H02K 3/28

(52) U.S. Cl. CPC H02K 3/28; H02K 2213/03

(57) ABSTRACT

A coil includes a center portion arranged in a slot of a stator core, and an end portion protruding in an axial direction from the stator core. The end portion has a first portion, and a second portion thinner than the thickness of the first portion.

### FIELD

The present disclosure relates to a coil, a stator, and a motor.

### BACKGROUND

A motor includes a stator and a rotor. The stator includes a stator core and a coil. An example of stator winding wire is disclosed in Patent Literature 1.

### CITATION LIST

### Patent Literature

Patent Literature 1: Japanese Patent Application Laid-open No. 2016-073148

### SUMMARY

### Technical Problem

Full-pitch winding and short-pitch winding are known as winding methods of a coil. The full-pitch winding means a winding method in which a pole pitch of a rotor and a coil pitch of a stator are equal. The short-pitch winding means a winding method in which the coil pitch of the stator is smaller than the pole pitch of the rotor. For example, in a case where a coil of a switched reluctance motor is wound in the full-pitch winding, torque per unit volume of a stator of the full-pitch winding motor is larger than that of a short-pitch winding motor. However, a coil end of the full-pitch winding motor becomes larger than that of the short-pitch winding motor, and significant improvement in torque density of the motor cannot be expected. In addition, depending on a structure of the stator, without employment of a split stator core, it may be difficult to insert a molded coil into a slot of the stator core.

The present disclosure is to control a size of a coil end portion.

### Solution to Problem

According to an aspect of the present invention, a coil comprises: a center portion arranged in a slot of a stator core; and an end portion protruding in an axial direction from the stator core, wherein the end portion has a first portion, and a second portion thinner than a thickness of the first portion.

### Advantageous Effects of Invention

According to the present disclosure, a size of a coil end portion can be controlled.

### BRIEF DESCRIPTION OF DRAWINGS

FIG. 1 is a view schematically illustrating a motor according to the present embodiment.

FIG. 2 is a perspective view illustrating a part of a stator according to the present embodiment.

FIG. 3 is a view schematically illustrating the stator and a rotor according to the present embodiment.

FIG. 4 is a view schematically illustrating teeth and coils according to the present embodiment.

FIG. 5 is a perspective view illustrating a coil set according to the present embodiment.

FIG. 6 is a plan view illustrating the coil set according to the present embodiment.

FIG. 7 is a flowchart illustrating a manufacturing method of the stator according to the present embodiment.

FIG. 8 is a perspective view illustrating a first coil piece of a segment conductor according to the present embodiment.

FIG. 9 is a perspective view illustrating a second coil piece of the segment conductor according to the present embodiment.

FIG. 10 is a perspective view illustrating the segment conductor according to the present embodiment.

FIG. 11 is a perspective view illustrating a U-phase coil according to the present embodiment.

FIG. 12 is a perspective view illustrating a V-phase coil according to the present embodiment.

FIG. 13 is a view schematically illustrating slots according to the present embodiment.

FIG. 14 is a view schematically illustrating a second coil piece according to the present embodiment.

FIG. 15 is a view schematically illustrating a manufacturing method of the second coil piece illustrated in FIG. 14.

FIG. 16 is a view schematically illustrating a manufacturing method of the first coil piece illustrated in FIG. 8.

### DESCRIPTION OF EMBODIMENTS

In the following, embodiments according to the present disclosure will be described with reference to the drawings, but the present invention is not limited thereto. Components of the embodiments described in the following can be arbitrarily combined. Also, there is a case where a part of the components is not used.

[Motor]

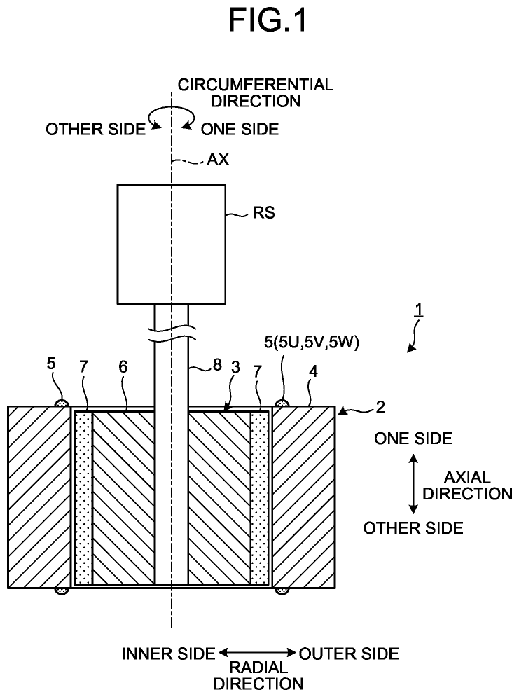

FIG. 1 is a view schematically illustrating a motor 1 according to the present embodiment. In the present embodiment, the motor 1 is a segment-type switched reluctance motor. As illustrated in FIG. 1, the motor 1 includes a stator 2 and a rotor 3.

The stator 2 is substantially cylindrical. An inner peripheral surface of the stator 2 and an outer peripheral surface of the rotor 3 face each other with a gap interposed therebetween. The rotor 3 rotates about a rotation axis AX. The rotation axis AX of the rotor 3 substantially coincides with a central axis of the stator 2.

In the present embodiment, a direction parallel to the rotation axis AX is appropriately referred to as an axial direction, a direction around the rotation axis AX is appropriately referred to as a circumferential direction, and a radiation direction of the rotation axis AX is appropriately referred to as a radial direction.

Also, a direction or a position becoming away in a prescribed direction from a center of the motor 1 in the axial direction is appropriately referred to as one side in the axial direction, and an opposite side in the axial direction of the one side in the axial direction is appropriately referred to as the other side in the axial direction. Also, a prescribed rotation direction in the circumferential direction is appropriately referred to as one side in the circumferential direction, and an opposite side in the circumferential direction of the one side in the circumferential direction is appropriately referred to as the other side in the circumferential direction. Furthermore, a direction or a position becoming away from the central axis AX in the radial direction is appropriately referred to as an outer side in the radial direction, and an opposite side in the radial direction of the outer side in the radial direction is appropriately referred to as an inner side in the radial direction.

The stator 2 includes a stator core 4, and coils 5 supported by the stator core 4. The rotor 3 is arranged in such a manner as to face the stator core 4. In the present embodiment, the rotor 3 is arranged on an inner side of the stator core 4. The rotor 3 includes a rotor holder 6, and rotor core pieces 7 held by the rotor holder 6. The rotor holder 6 is a non-magnetic body. The rotor core pieces 7 are magnetic bodies. The rotor core pieces 7 function as poles of the rotor 3.

The motor 1 is a three-phase motor. The coils 5 include a U-phase coil 5U, a V-phase coil 5V, and a W-phase coil 5W.

The rotor 3 is connected to an object RS via a shaft 8. Examples of the object RS include an engine mounted on a hybrid excavator that is a kind of a construction machine. The motor 1 functions as a generator driven by the engine.

[Stator]

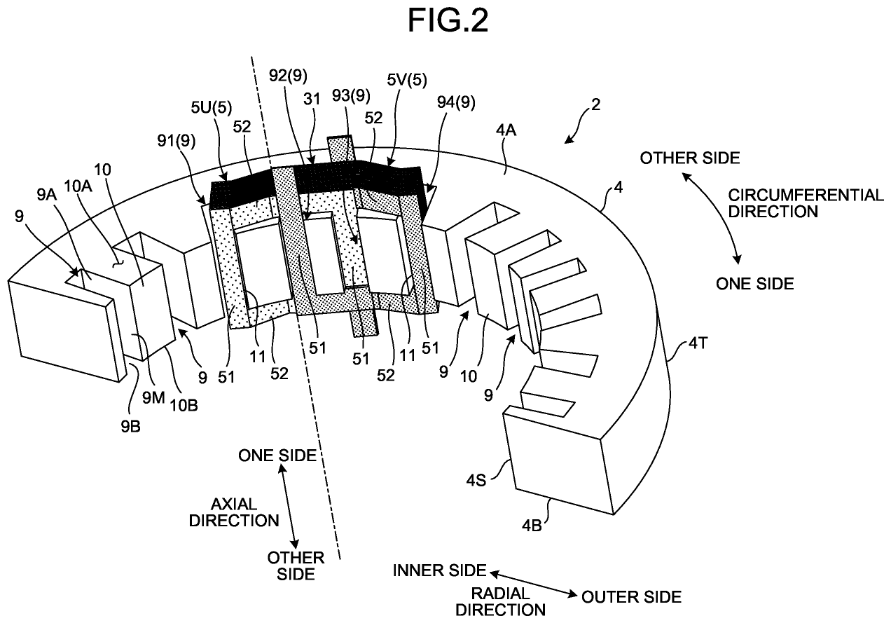

FIG. 2 is a perspective view illustrating a part of the stator 2 according to the present embodiment. As illustrated in FIG. 2, the stator 2 includes the stator core 4, and the coils 5 arranged in slots 9 of the stator core 4.

The stator core 4 has an inner peripheral surface 4S, an outer peripheral surface 4T, a first end surface 4A, and a second end surface 4B. The inner peripheral surface 4S faces the inner side in the radial direction. The outer peripheral surface 4T faces the outer side in the radial direction. The first end surface 4A faces one side in the axial direction. The second end surface 4B faces the other side in the axial direction. The first end surface 4A connects an end on the one side in the axial direction of the inner peripheral surface 4S and an end on the one side in the axial direction of the outer peripheral surface 4T. The second end surface 4B connects an end on the other side in the axial direction of the inner peripheral surface 4S and an end on the other side in the axial direction of the outer peripheral surface 4T.

The plurality of slots 9 is provided in the circumferential direction in the inner peripheral surface 4S. The slots 9 are recessed from the inner peripheral surface 4S toward the outer side in the radial direction. The slots 9 extend in the axial direction. Each of the slots 9 has an opening portion 9M provided in the inner peripheral surface 4S and facing the inner side in the radial direction, an opening portion 9A provided in the first end surface 4A and facing the one side in the axial direction, and an opening portion 9B provided in the second end surface 4B and facing the other side in the axial direction.

Also, the stator core 4 has teeth 10 arranged between the slots 9 adjacent to each other in the circumferential direction.

The teeth 10 support the coils 5. Each of the teeth 10 has an end surface 10A facing the one side in the axial direction, and an end surface 10B facing the other side in the axial direction. The first end surface 4A includes the end surface 10A. The second end surface 4B includes the end surface 10B.

The coils 5 are supported by the teeth 10. The coils 5 have openings 11. The teeth 10 are inserted into the openings 11 of the coils 5. A part of the coils 5 is arranged on an inner side of the slots 9. A part of the coils 5 protrudes in the axial direction from the stator core 4.

In the following description, a portion of each of the coils 5 which portion is arranged on the inner side of the slot 9 will be appropriately referred to as a coil center portion 51, and a portion of each of the coils 5 which portion protrudes in the axial direction from the stator core 4 will be appropriately referred to as a coil end portion 52.

Each of the coils 5 has two coil center portions 51. Each of the coils 5 has two coil end portions 52. In a case where one of the coil center portions 51 is arranged in a predetermined slot 9, the other coil center portion 51 is arranged in a slot 9 different from the slot 9 in which the one coil center portion 51 is arranged. The coil end portions 52 include a first coil end portion 52 protruding from the first end surface 4A of the stator core 4 to the one side in the axial direction, and a second coil end portion 52 protruding from the second end surface 4B of the stator core 4 to the other side in the axial direction.

As described above, the coils 5 include the U-phase coil 5U, the V-phase coil 5V, and the W-phase coil 5W. The U-phase coil 5U and the V-phase coil 5V are illustrated in FIG. 2.

As illustrated in FIG. 2, the U-phase coil 5U and the V-phase coil 5V are overlapped. The U-phase coil 5U and the V-phase coil 5V are overlapped in such a manner that a part of the V-phase coil 5V is arranged between parts of the U-phase coil 5U and a part of the U-phase coil 5U is arranged between parts of the V-phase coil 5V, whereby a coil set 31 of the U-phase coil 5U and the V-phase coil 5V is formed.

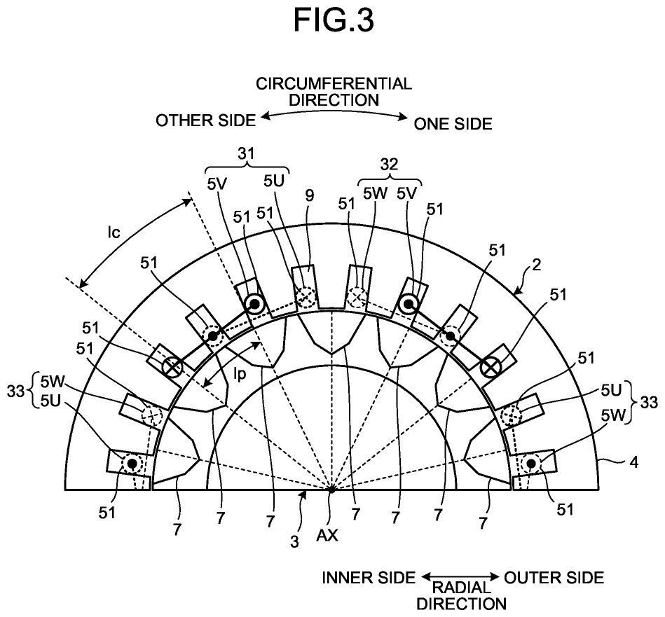

Similarly to the coil set 31, the V-phase coil 5V and the W-phase coil 5W are overlapped in such a manner that a part of the W-phase coil 5W is arranged between parts of the V-phase coil 5V and a part of the V-phase coil 5V is arranged between parts of the W-phase coil 5W, whereby a coil set 32 of the V-phase coil 5V and the W-phase coil 5W is formed. The W-phase coil 5W and the U-phase coil 5U are overlapped in such a manner that a part of the U-phase coil 5U is arranged between parts of the W-phase coil 5W and a part of the W-phase coil 5W is arranged between parts of the U-phase coil 5U, whereby a coil set 33 of the W-phase coil 5W and the U-phase coil 5U is formed. The stator core 4 supports each of the coil set 31, the coil set 32, and the coil set 33 (see FIG. 3).

The coils 5 are arranged around the teeth 10 at a pitch of two slots. That is, in a case where one coil center portion 51 of one coil 5 is arranged in a predetermined slot 9, the other coil center portion 51 is arranged in a slot 9 that is two slots away from the slot 9 in which the one coil center portion 51 is arranged in the circumferential direction.

In the example illustrated in FIG. 2, the slots 9 include a first slot 91, a second slot 92 arranged adjacent to the first slot 91 on the one side in the circumferential direction, a third slot 93 arranged adjacent to the second slot 92 on the one side in the circumferential direction, and a fourth slot 94 arranged adjacent to the third slot 93 on the one side in the circumferential direction.

The other coil center portion 51 of the U-phase coil 5U is arranged in the first slot 91. The other coil center portion 51 of the V-phase coil 5V is arranged in the second slot 92. One coil center portion 51 of the U-phase coil 5U is arranged in the third slot 93. One coil center portion 51 of the V-phase coil 5V is arranged in the fourth slot 94.

A relationship of the V-phase coil 5V and the W-phase coil 5W of the coil set 32 with the plurality of slots 9, and a relationship of the W-phase coil 5W and the U-phase coil 5U of the coil set 33 with the plurality of slots 9 are similar to a relationship of the U-phase coil 5U and the V-phase coil 5V of the coil set 31 with the plurality of slots 9.

[Relationship between the number of poles and the number of slots]

FIG. 3 is a view schematically illustrating the stator 2 and the rotor 3 according to the present embodiment. The stator 2 and the rotor 3 divided in half are illustrated in FIG. 3. Note that polarity of a winding wire illustrated in FIG. 3 is an example. The polarity of the winding wire is established in a direction illustrated in FIG. 3 or in a direction opposite to the direction illustrated in FIG. 3.

As illustrated in FIG. 3, each of the coil set 31 of the U-phase coil 5U and the V-phase coil 5V, the coil set 32 of the V-phase coil 5V and the W-phase coil 5W, and the coil set 33 of the W-phase coil 5W and the U-phase coil 5U is supported by the stator core 4. Each of the U-phase coils 5U, the V-phase coils 5V, and the W-phase coils 5W is arranged around the teeth 10 at a pitch of two slots.

The rotor 3 has the plurality of rotor core pieces 7. The plurality of rotor core pieces 7 has the same shape and the same size. The plurality of rotor core pieces 7 is arranged at equal intervals in the circumferential direction. The rotor core pieces 7 function as poles of the rotor 3. The number of poles of the rotor 3 means the number of rotor core pieces 7.

In the present embodiment, when the number of poles of the rotor 3 is P, the number of slots of the stator core 4 is S, and a natural number is N, the motor 1 satisfies conditions of the following expression (1) and expression (2).

P=7×N (1)

S=12×N (2)

That is, a 7-pole 12-slot motor, a 14-pole 24-slot motor, and a 21-pole 36-slot motor are exemplified as the motor 1 according to the present embodiment.

In the present embodiment, the number of poles P and the number of slots S are determined in such a manner that at least two coil center portions 51 of the U-phase coil 5U, the V-phase coil 5V, and the W-phase coil 5W face two rotor core pieces 7 adjacent to each other in the circumferential direction in a rotation of the rotor 3. In the example illustrated in FIG. 3, two coil center portions 51 of the V-phase coil 5V and two rotor core pieces 7 adjacent to each other in the circumferential direction face each other at the same time. When the rotor 3 rotates, a state in which two coil center portions 51 of the U-phase coil 5U and two rotor core pieces 7 adjacent to each other in the circumferential direction face each other at the same time is generated. Furthermore, when the rotor 3 rotates, a state in which two coil center portions 51 of the W-phase coil 5W and two rotor core pieces 7 adjacent to each other in the circumferential direction face each other at the same time is generated.

As described above, in the present embodiment, the number of poles P and the number of slots S are determined in such a manner that a coil pitch Ic of the U-phase coil 5U, a coil pitch Ic of the V-phase coil 5V, and a coil pitch Ic of the W-phase coil 5W are substantially equal to a pole pitch Ip of the rotor 3.

In the present embodiment, the coil pitch Ic means an angle formed by one coil center portion 51 and the other coil center portion 51 of one coil 5 with reference to the rotation axis AX. The pole pitch Ip means an angle formed by two rotor core pieces 7 adjacent to each other in the circumferential direction with reference to the rotation axis AX.

[Tooth]

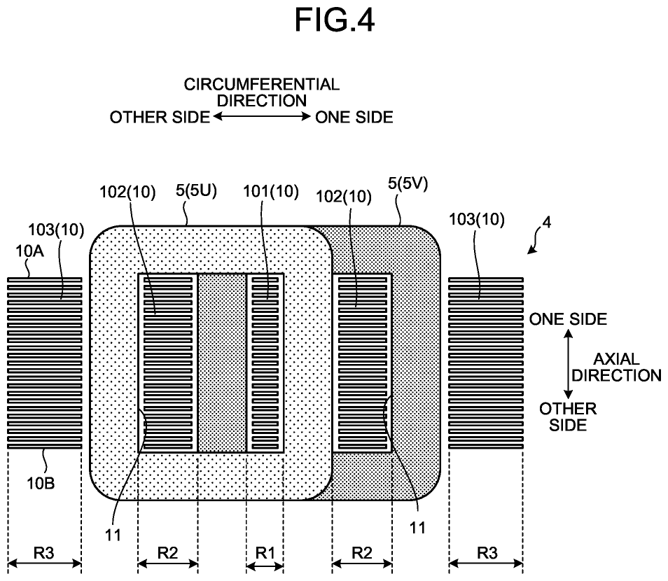

FIG. 4 is a view schematically illustrating the teeth 10 and the coils 5 according to the present embodiment. FIG. 4 corresponds to a view in which the stator core 4 is viewed from the inner side in the radial direction. As illustrated in FIG. 3 and FIG. 4, the teeth 10 include a first tooth 101 arranged in both of the opening 11 of the U-phase coil 5U and the opening 11 of the V-phase coil 5V of the coil set 31, a second tooth 102 arranged in one of the opening 11 of the U-phase coil 5U and the opening 11 of the V-phase coil 5V, and a third tooth 103 arranged in neither the opening 11 of the U-phase coil 5U nor the opening 11 of the V-phase coil 5V.

That is, the first tooth 101 is a tooth 10 arranged on an inner side of the openings 11 of the two coils 5. The second tooth 102 is a tooth 10 arranged on the inner side of the opening 11 of one coil 5. The third tooth 103 is a tooth 10 that is not arranged on the inner side of the openings 11 of the coils 5.

The first tooth 101 includes a tooth 10 arranged in both the opening 11 of the V-phase coil 5V and the opening 11 of the W-phase coil 5W of the coil set 32, and a tooth 10 arranged in both of the opening 11 of the W-phase coil 5W and the opening 11 of the U-phase coil 5U of the coil set 33.

The second tooth 102 includes a tooth 10 arranged in one of the opening 11 of the V-phase coil 5V and the opening 11 of the W-phase coil 5W of the coil set 32, and a tooth 10 arranged in one of the opening 11 of the W-phase coil 5W and the opening 11 of the U-phase coil 5U of the coil set 33.

The third tooth 103 includes a tooth 10 arranged in neither the opening 11 of the V-phase coil 5V nor the opening 11 of the W-phase coil 5W of the coil set 32, and a tooth 10 arranged in neither the opening 11 of the W-phase coil 5W nor the opening 11 of the U-phase coil 5U of the coil set 33.

In other words, the first tooth 101 is a tooth 10 in which the end surface 10A and the end surface 10B face two coils 5. The second tooth 102 is a tooth 10 in which the end surface 10A and the end surface 10B face one coil 5. The third tooth 103 is a tooth 10 in which the end surface 10A and the end surface 10B do not face the coils 5.

As illustrated in FIG. 4, among the first tooth 101, the second tooth 102, and the third tooth 103, a size R1 of the first tooth 101 is the smallest, a size R2 of the second tooth 102 is the second smallest after the first tooth 101, and a size R3 of the third tooth 103 is the largest in the circumferential direction.

[Coil]

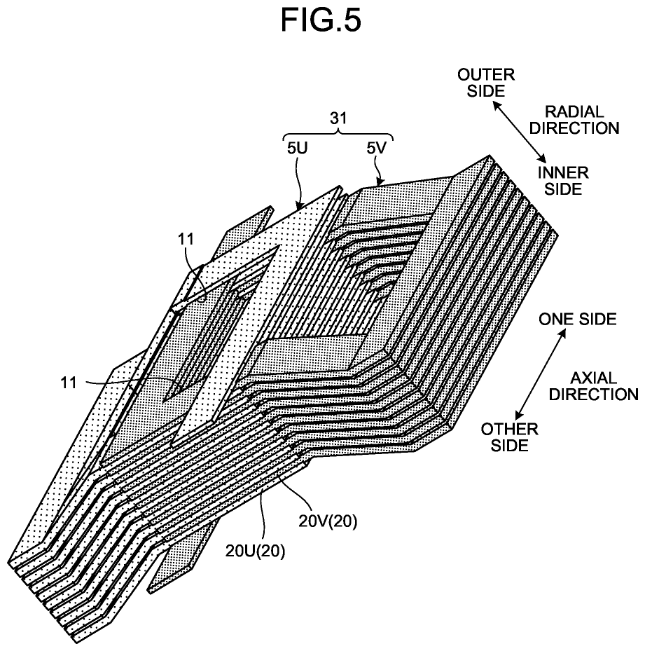

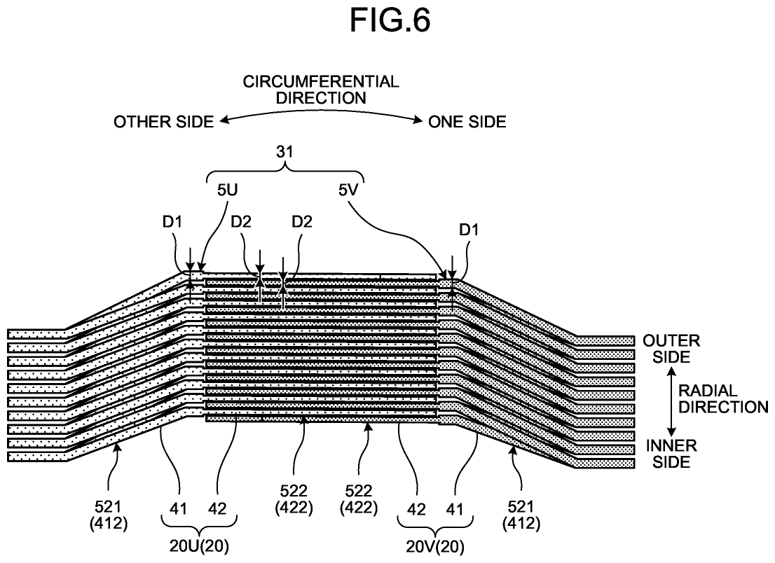

FIG. 5 is a perspective view illustrating the coil set 31 according to the present embodiment. FIG. 6 is a plan view illustrating the coil set 31 according to the present embodiment. The coil set 31 includes the U-phase coil 5U and the V-phase coil 5V. In the present embodiment, each of the coils 5 includes plate-shaped segment conductors 20. The segment conductors 20 include a segment conductor 20U included in the U-phase coil 5U and a segment conductor 20V included in the V-phase coil 5V. Note that the segment conductors 20 include a segment conductor 20W included in the W-phase coil 5W although not illustrated in FIG. 5 and

FIG. 6.

The plurality of segment conductors 20 is connected in a spiral shape, whereby each of the coils 5 is formed. The U-phase coil 5U includes a plurality of the segment conductors 20U connected in a spiral shape. The V-phase coil 5V includes a plurality of the segment conductors 20V connected in a spiral shape. A part of the segment conductors 20V of the V-phase coil 5V is arranged between the segment conductors 20U of the U-phase coil 5U. The segment conductors 20U of the U-phase coil 5U and the segment conductors 20V of the V-phase coil 5V are alternately arranged in the radial direction. Since the part of the V-phase coil 5V is arranged between the parts of the U-phase coil 5U, the U-phase coil 5U and the V-phase coil 5V are overlapped, and the coil set 31 of the U-phase coil 5U and the V-phase coil 5V is formed.

Similarly, since a part of the W-phase coil 5W is arranged between parts of the V-phase coil 5V, the V-phase coil 5V and the W-phase coil 5W are overlapped, and the coil set 32 of the V-phase coil 5V and the W-phase coil 5W is formed. Since a part of the U-phase coil 5U is arranged between parts of the W-phase coil 5W, the W-phase coil 5W and the U-phase coil 5U are overlapped, and the coil set 33 of the W-phase coil 5W and the U-phase coil 5U is formed. A stator core 4 supports each of the coil set 31, the coil set 32, and the coil set 33.

[Manufacturing Method]

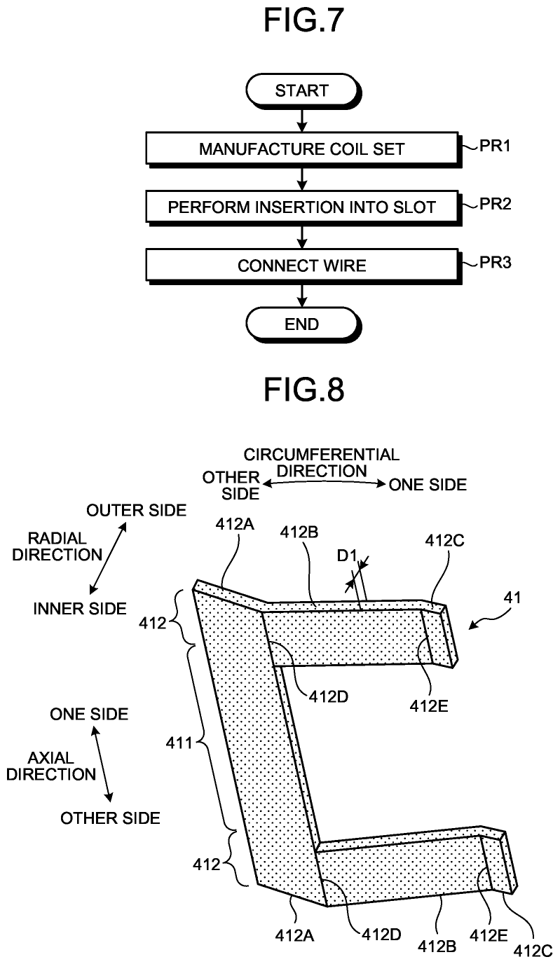

FIG. 7 is a flowchart illustrating a manufacturing method of the stator 2 according to the present embodiment. As illustrated in FIG. 7, the stator 2 is manufactured by a manufacturing method including a process PR1 of manufacturing the coil sets, a process PR2 of inserting the coil sets into the slots 9, and a process PR3 of connecting the plurality of coil sets.

In a case where the coil set 31 is manufactured, first, each of the U-phase coil 5U and the V-phase coil 5V is manufactured.

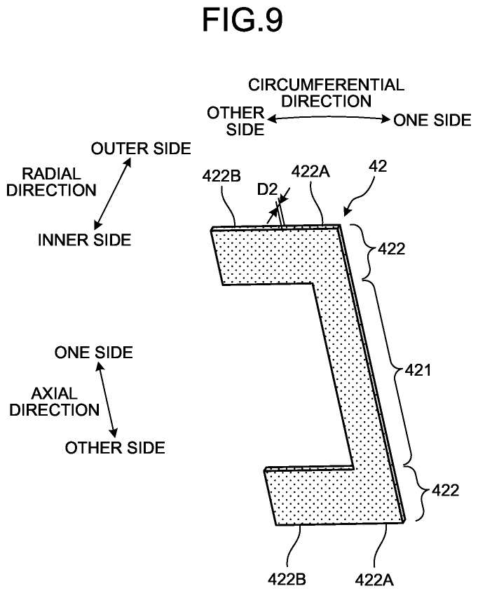

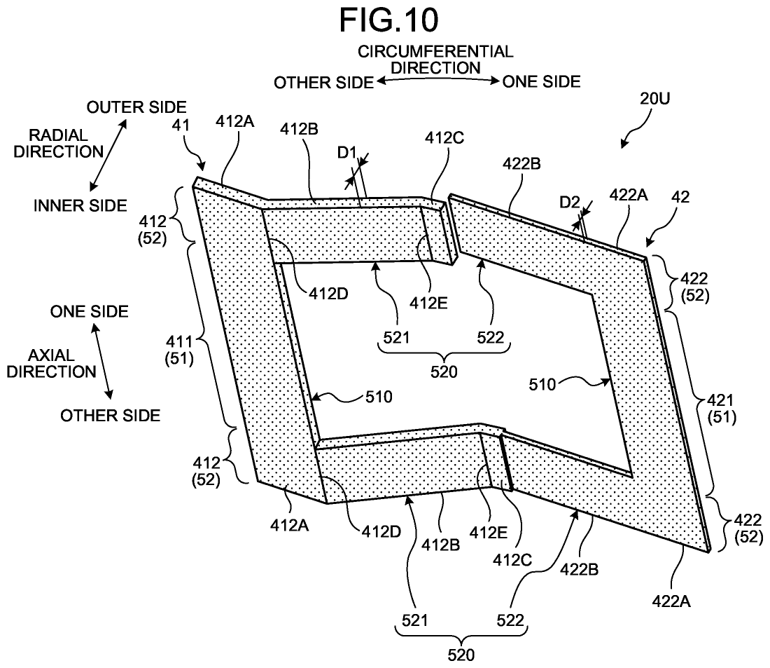

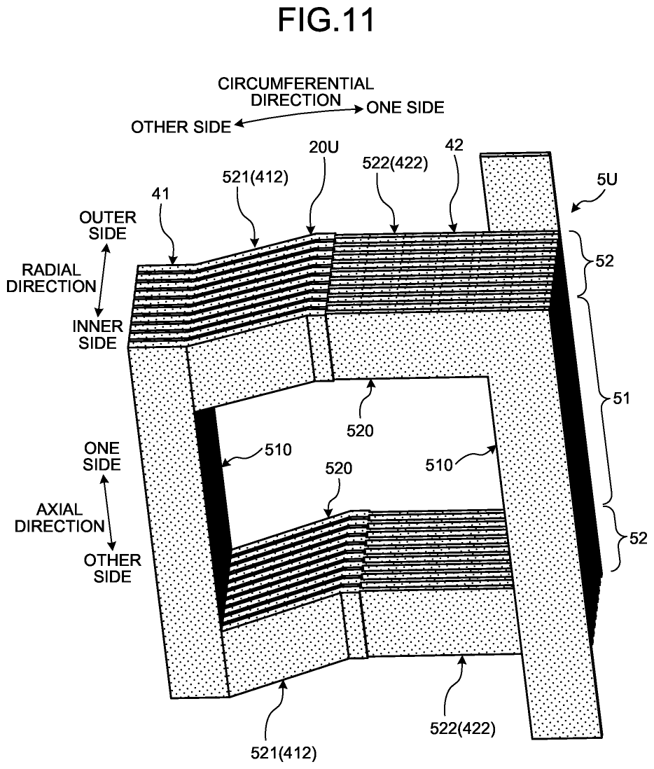

Each of FIG. 8, FIG. 9, FIG. 10, and FIG. 11 is a view for describing a manufacturing method of the U-phase coil 5U. The plurality of segment conductors 20U is connected in the spiral shape, whereby the U-phase coil 5U is manufactured. Each of the segment conductors 20U is manufactured by connection of a first coil piece 41 and a second coil piece 42. FIG. 8 is a perspective view illustrating the first coil piece 41 of the segment conductors 20U according to the present embodiment. FIG. 9 is a perspective view illustrating the second coil piece 42 of the segment conductors 20U according to the present embodiment. FIG. 10 is a perspective view illustrating each of the segment conductors 20U according to the present embodiment. FIG. 11 is a perspective view illustrating the U-phase coil 5U according to the present embodiment.

As illustrated in FIG. 8, the first coil piece 41 is a plate-shaped member having a thickness D1. The thickness D1 means a size in the radial direction of the first coil piece 41. The first coil piece 41 has a center portion 411 extending in the axial direction, and end portions 412 respectively continuous with an end on the one side in the axial direction and an end on the other side in the axial direction of the center portion 411. The two end portions 412 respectively extend from the ends in the axial direction of the center portion 411 toward the one side in the circumferential direction.

The end portions 412 include first end portions 412A respectively continuous with the ends in the axial direction of the center portion 411, second end portions 412B respectively continuous with ends on the one side in the circumferential direction of the first end portions 412A via first bent portions 412D, and third end portions 412C respectively continuous with ends on the one side in the circumferential direction of the second end portions 412B via second bent portions 412E. Each of the first bent portions 412D is bent in such a manner that a corner portion on the inner side in the radial direction of the first bent portion 412D protrudes toward the inner side in the radial direction. Each of the second bent portions 412E is bent in such a manner that a corner portion on the outer side in the radial direction of the second bent portion 412E protrudes toward the outer side in the radial direction. A surface of each of the first end portions 412A is arranged in the same plane as a surface of the center portion 411. The second end portions 412B are inclined on the outer side in the radial direction toward the one side in the circumferential direction. The third end portions 412C are inclined on the inner side in the radial direction toward the one side in the circumferential direction.

The center portions 411 are arranged on the inner side of the slots 9 of the stator core 4. The end portions 412 protrude in the axial direction from the stator core 4. The center portions 411 form a coil center portion 51. Each of the end portions 412 forms the coil end portion 52.

As illustrated in FIG. 9, the second coil piece 42 is a plate-shaped member having a thickness D2. The thickness D2 means a size in the radial direction of the second coil piece 42. The thickness D2 of the second coil piece 42 is smaller than the thickness D1 of the first coil piece 41. The second coil piece 42 has a center portion 421 extending in the axial direction, and end portions 422 respectively continuous with an end on the one side in the axial direction and an end on the other side in the axial direction of the center portion 421. The two end portions 422 respectively extend from the ends in the axial direction of the center portion 421 toward the one side in the circumferential direction.

The end portions 422 include fourth end portions 422A respectively continuous with the ends in the axial direction of the center portion 421, and fifth end portions 422B respectively continuous with ends on the one side in the circumferential direction of the fourth end portions 422A. A surface of each of the end portions 422 is arranged in the same plane as a surface of the center portion 421.

The center portions 421 are arranged on the inner side of the slots 9 of the stator core 4. The end portions 422 protrude in the axial direction from the stator core 4. The center portions 421 form the coil center portion 51. Each of the end portions 422 forms the coil end portion 52.

As illustrated in FIG. 10, the end portions 412 of the first coil piece 41 and the end portions 422 of the second coil piece 42 are connected, whereby each of the segment conductors 20U is formed. In the example illustrated in FIG. 10, the third end portion 412C of the end portion 412 on the other side in the axial direction and the fifth end portion 422B of the end portion 422 on the other side in the axial direction are connected. An end on the one side in the circumferential direction of the third end portion 412C and an end on the other side in the circumferential direction of the fifth end portion 422B are connected.

The first coil piece 41 and the second coil piece 42 may be connected by welding, may be connected by caulking, may be connected by press-fitting, or may be connected by pressure-welding of an end surface of the third end portion 412C and an end surface of the fifth end portion 422B.

Each of the segment conductors 20U includes center portions 510 arranged in the slots 9 of the stator core 4, and end portions 520 protruding in the axial direction from the stator core 4. The center portions 510 of the segment conductor 20U include the center portion 411 of the first coil piece 41 and the center portion 421 of the second coil piece 42. The end portions 520 of the segment conductor 20U include the end portions 412 of the first coil piece 41 and the end portions 422 of the second coil piece 42.

As described above, the thickness D2 of the end portions 422 is smaller than the thickness D1 of the end portions 412. Since the first coil piece 41 and the second coil piece 42 are connected, each of the end portions 520 of the segment conductor 20U includes a first portion 521, and a second portion 522 thinner than a thickness of the first portion 521. The first portion 521 includes the end portion 412 of the first coil piece 41. The second portion 522 includes the end portion 422 of the second coil piece 42. The thickness D1 of the first portion 521 is larger than the thickness D2 of the second portion 522. In the present embodiment, the thickness D1 of the first portion 521 is twice the thickness D2 of the second portion 522. For example, in a case where the thickness D2 is 0.4 mm, the thickness D1 is set to 0.8 mm.

Also, a cross-sectional area of the first portion 521 is larger than a cross-sectional area of the second portion 522.

Also, a thickness of the center portion 411 is equal to the thickness D1 of the first portion 521 and is larger than the thickness D2 of the second portion 522. The thickness of the center portion 421 is equal to the thickness D2 of the second portion 522. A cross-sectional area of the center portion 411 is equal to the cross-sectional area of the first portion 521.

In such a manner, in the present embodiment, the first portion 521 including the end portion 412 of the first coil piece 41 and the second portion 522 including the end portion 422 of the second coil piece 42 thinner than the thickness D1 of the first portion 521 are connected, whereby the segment conductor 20U of the U-phase coil 5U is formed.

A plurality of the segment conductors 20U in a manner illustrated in FIG. 10 is manufactured. An end portion 412 on the one side in the axial direction of a first segment conductor 20U and an end portion 422 on the one side in the axial direction of a second segment conductor 20U are connected. End portions 412 and end portions 422 of different segment conductors 20U are sequentially connected, whereby the plurality of segment conductors 20U is connected in the spiral shape. As a result, as illustrated in FIG. 11, the U-phase coil 5U including the plurality of segment conductors 20U is manufactured.

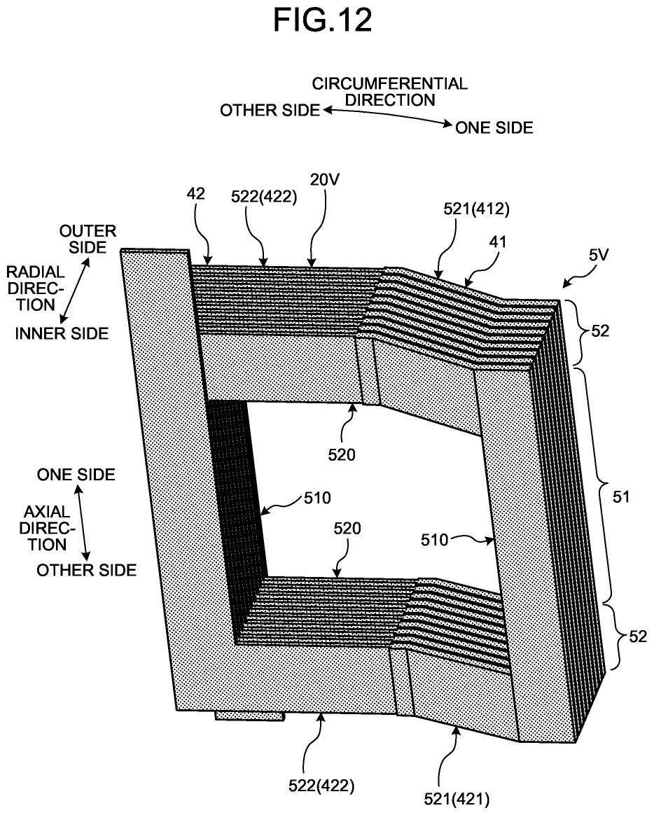

FIG. 12 is a perspective view illustrating the V-phase coil 5V according to the present embodiment. Similarly to the U-phase coil 5U, the V-phase coil 5V includes center portions 510 and end portions 520. Each of the end portions 520 has a first portion 521 and a second portion 522 thinner than the thickness of the first portion 521. A manufacturing method of the V-phase coil 5V is similar to the manufacturing method of the U-phase coil 5U. Also, a shape and a size of the U-phase coil 5U and a shape and a size of the V-phase coil 5V are substantially equal to each other. In a case where the first coil piece 41 and the second coil piece 42 are manufactured by utilization of molds, the first coil piece 41 and the second coil piece 42 of the U-phase coil 5U and the first coil piece 41 and the second coil piece 42 of the V-phase coil 5V can be manufactured by utilization of the same molds. A description of the manufacturing method of the V-phase coil 5V is omitted.

After each of the U-phase coil 5U and the V-phase coil 5V is manufactured, a part of the segment conductors 20V of the V-phase coil 5V is arranged between the segment conductors 20U of the U-phase coil 5U. As illustrated in FIG. 6, in each of the coil end portions 52, the second portions 522 of the U-phase coil 5U and the second portions 522 of the V-phase coil 5V are alternately arranged in the radial direction. In the example illustrated in FIG. 6, the second portions 522 of the U-phase coil 5U are arranged on the one side in the circumferential direction of the first portions 521 of the U-phase coil 5U. The second portions 522 of the V-phase coil 5V are arranged on the other side in the circumferential direction of the first portions 521 of the V-phase coil 5V. The second portions 522 of the V-phase coil 5V are arranged between the second portions 522 of the U-phase coil 5U.

As an example of the arrangement method, a spiral-shaped winding wires are appropriately extended in the radial direction, and then combined while being guided by a jig or the like, which simulates a stator shape, in such a manner that coil end portions of different phases are alternately overlapped in the radial direction. Then, the extended winding wires are compressed in the radial direction, and a shape is fixed by mechanical or thermal treatment.

The U-phase coil 5U and the V-phase coil 5V are overlapped in such a manner that the second portions 522 of the segment conductors 20U of the U-phase coil 5U and the second portions 522 of the segment conductors 20V of the V-phase coil 5V are alternately arranged in the radial direction, whereby the coil set 31 of the U-phase coil 5U and the V-phase coil 5V is manufactured. Similarly, in each of the coil end portions 52, the V-phase coil 5V and the W-phase coil 5W are overlapped in such a manner that the second portions 522 of the V-phase coil 5V and the second portions 522 of the W-phase coil 5W are alternately arranged in the radial direction, whereby the coil set 32 of the V-phase coil 5V and the W-phase coil 5W is manufactured. In each of the coil end portions 52, the W-phase coil 5W and the U-phase coil 5U are overlapped in such a manner that the second portions 522 of the W-phase coil 5W and the second portions 522 of the U-phase coil 5U are alternately arranged in the radial direction, whereby the coil set 33 of the W-phase coil 5W and the U-phase coil 5U is manufactured (Process PR1).

Each of the coil end portions 52 of the coil set 31, the coil set 32, and the coil set 33 has the first portions 521 and the second portions 522. After the coil set 31, the coil set 32, and the coil set 33 are manufactured, the coil set 31, the coil set 32, and the coil set 33 are respectively inserted into the slots 9 from the inner side in the radial direction. Each of the U-phase coil 5U, the V-phase coil 5V, and the W-phase coil 5W is attached to the stator core 4 in such a manner that the first portions 521 and the second portions 522 protrude in the axial direction from the stator core 4.

As illustrated in FIG. 3, the coil set 33 is arranged on the one side in the circumferential direction of the coil set 32, and the coil set 32 is arranged on the one side in the circumferential direction of the coil set 31. One coil center portion 51 is arranged in each of the plurality of slots 9 (Process PR2).

After the coil set 31, the coil set 32, and the coil set 33 are respectively inserted into the slots 9, the plurality of coils 5 is connected by a wire connection member (Process PR3).

In the middle of the coil manufacturing process, appropriate insulation processing between the coils and the stator, or between the coils in the same phase or in different phases is performed.

From the above, the stator 2 is manufactured.

[Effect]

As described above, according to the present embodiment, each of the end portions 520 of the coils 5 has the first portions 521 and the second portions 522 thinner than the thickness of the first portions 521. For example, in a case where the coil set 31 is formed, the U-phase coil 5U and the V-phase coil 5V are overlapped in such a manner that the second portions 522 of the U-phase coil 5U and the second portions 522 of the V-phase coil 5V are alternately arranged in the radial direction in each of the coil end portions 52, whereby the size of the coil end portion 52 can be controlled.

For example, in a case where the thickness of the end portions 520 of the segment conductors 20 is uniform, the coil end portions 52 become large when the plurality of coils 5 overlaps in the coil end portions 52. The coil end portions 52 do not contribute to generation of torque by the motor 1. Thus, when the coil end portions 52 become large, the motor 1 increases in size although the torque generated by the motor 1 does not increase. As a result, torque density of the motor 1 decreases. The torque density means a value acquired by division of the torque, which can be generated by the motor 1, by mass or volume of the motor 1. The torque density is preferably large.

According to the present embodiment, the second portions 522 of the two coils 5 overlap in each of the coil end portions 52. Also, in the coil end portion 52, the first portions 521 of the coils 5 do not overlap with the other coils 5. Thus, the coil end portion 52 is prevented from becoming large. Thus, an increase in size of the motor 1 is controlled.

In the present embodiment, the thickness D2 of the second portions 522 is larger than the thickness D1 of the first portions 521. The thickness D2 of the second portions 522 is half the thickness D1 of the first portions 521. Thus, as described with reference to FIG. 6, when the second portions 522 of the U-phase coil 5U and the second portions 522 of the V-phase coil 5V are alternately arranged in the radial direction, the total value of the thickness D2 of the plurality of second portions 522 and the total value of the thickness D1 of the plurality of first portions 521 can be made substantially equal.

In the present embodiment, the motor 1 satisfies the conditions of the expression (1) and expression (2). In the 7-pole 12-slot motor 1, the coils 5 can be arranged at a pitch of two slots. Thus, the size of the coil end portions 52 can be controlled.

For example, in a case where coils are arranged at a pitch of three slots, three coils overlap in a coil end portion. As a result, the coil end portion becomes large. According to the present embodiment, the number of overlapping coils 5 in each of the coil end portions 52 is two. Thus, the coil end portion 52 is prevented from becoming large. Thus, an increase in size of the motor 1 is controlled.

Also, for example, the motor 1 having the coils 5 arranged at a pitch of two slots can generate larger torque than a motor having coils arranged at a pitch of one slot. That is, the motor 1 can generate sufficient torque since the coils are arranged at a pitch of two slots. Thus, a decrease in the torque density of the motor 1 is controlled.

Also, a coil pitch Ic of the two-slot pitch is smaller than a coil pitch of the three-slot pitch. Thus, according to the present embodiment, phase resistance of the coils 5 is reduced as compared with the three-slot pitch. Thus, deterioration in performance of the motor 1 is controlled. Although a resistance value increases in a portion with a small plate thickness in the segment conductors 20, the coil end portions 52 are easily hit by a refrigerant and are easily cooled. Thus, a problem is unlikely to be generated.

Also, in the present embodiment, since seven poles and 12 slots are employed, coil sets in each of which two coils 5 are combined can be molded and then the coil sets can be inserted into the slots 9 from the inner side in the radial direction. According to the present embodiment, for example, it is possible to insert the molded coils 5 (coil set) wound in a bobbin shape into the slots 9 of the stator core 4 without employing a split stator core. Thus, the motor 1 can be easily manufactured.

In the present embodiment, the teeth 10 include the first tooth 101 in which the end surface 10A and the end surface 10B face two coils 5, the second tooth 102 in which the end surface 10A and the end surface 10B face one coil 5, and the third tooth 103 in which the end surface 10A and the end surface 10B face no coil 5. The first tooth 101 is arranged on the inner side of the openings 11 of the two coils 5. The second tooth 102 is arranged on the inner side of the opening 11 of the one coil 5. The third tooth 103 is not arranged on the inner side of the openings 11 of the coils 5. In the circumferential direction, the size R1 of the first tooth 101 is the smallest, the size R2 of the second tooth 102 is the second smallest after the first tooth 101, and the size R3 of the third tooth 103 is the largest. The inventor of the present invention has found that the torque generated by the motor 1 is improved when the first tooth 101, the second tooth 102, and the third tooth 103 satisfy the condition of [R1<R2<R3]. It is considered that this is because a leakage flux is reduced and a magnetic flux can appropriately flow when the stator 2 is designed to satisfy the condition of [R1<R2<R3]. When the condition of [R1<R2<R3] is satisfied, the motor 1 can generate large torque.

The coil pitch Ic and the pole pitch Ip are determined in such a manner that the two coil center portions 51 of each of the coils 5 and the two adjacent rotor core pieces 7 face each other in the rotation of the rotor 3, whereby the motor 1 can generate torque appropriately.

### OTHER EMBODIMENTS

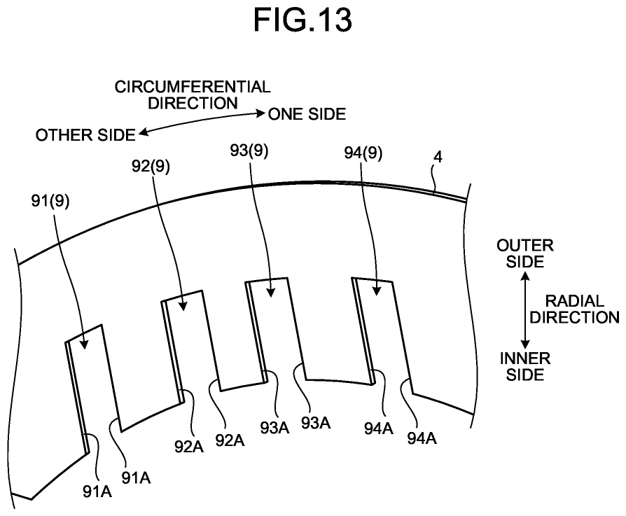

FIG. 13 is a view schematically illustrating slots 9 according to the present embodiment. As illustrated in FIG. 13, in a cross section orthogonal to a rotation axis AX, an inner surface 91A of a first slot 91, an inner surface 92A of a second slot 92, an inner surface 93A of a third slot 93, and an inner surface 94A of a fourth slot 94 have nearly parallel shapes. The inner surfaces of the slots 9 mean surfaces extending in each of an axial direction and a radial direction and facing inner peripheral surfaces of openings 11 of coils 5.

As described above, for example, in a case where a coil set 31 is inserted into the slots 9, the other coil center portion 51 of a U-phase coil 5U is arranged in the first slot 91, the other coil center portion 51 of a V-phase coil 5V is arranged in the second slot 92, one coil center portion 51 of the U-phase coil 5U is arranged in the third slot 93, and one coil center portion 51 of the V-phase coil 5V is arranged in the fourth slot. Since the inner surface 91A of the first slot 91, the inner surface 92A of the second slot 92, the inner surface 93A of the third slot 93, and the inner surface 94A of the fourth slot 94 have the nearly parallel shapes, the coil set 31 is smoothly inserted into the slots 9.

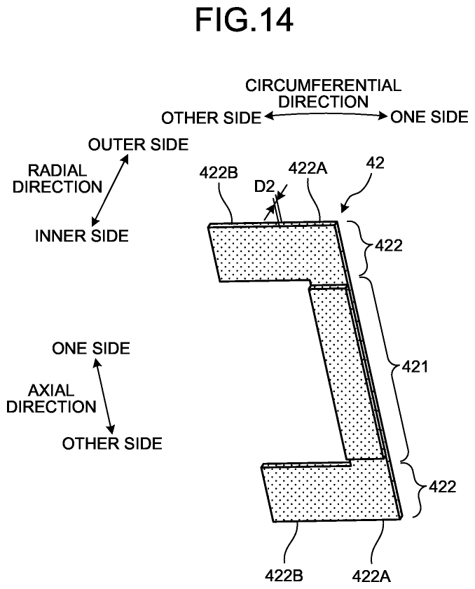

FIG. 14 is a view schematically illustrating a second coil piece 42 according to the present embodiment. In the above-described embodiment, the thickness D2 of the second coil piece 42 is uniform. That is, the thickness of the center portion 421 of the second coil piece 42 is equal to the thickness of the end portions 422. As illustrated in FIG. 14, a thickness of a center portion 421 may be larger than a thickness of end portions 422. In a case where the thickness of the center portion 421 is larger than the thickness of the end portions 422, a thickness of center portions 510 formed of a center portion 411 and the center portion 421 is larger than a thickness D2 of second portions 522. As the thickness of the center portions 510 increases, a large current can flow and a motor 1 can generate large torque. For example, the thickness of the center portions 510 formed of the center portion 411 and the center portion 421 may be equal to a thickness D1 of first portions 521. The second coil piece 42 in a manner illustrated in FIG. 14 is manufactured by cutting processing or rolling processing of a part of a thick coil piece.

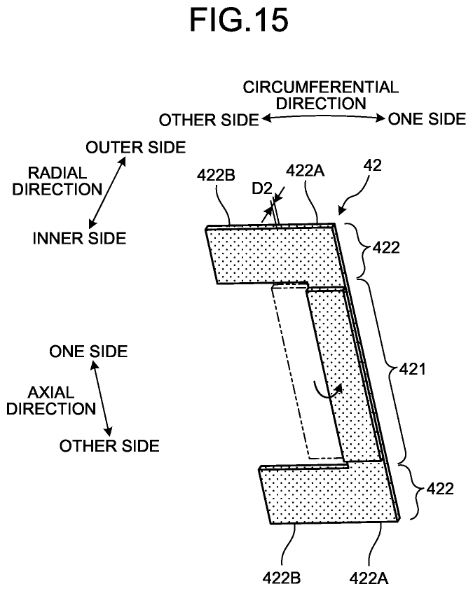

FIG. 15 is a view schematically illustrating a manufacturing method of the second coil piece 42 illustrated in FIG. 14. As illustrated in FIG. 15, the second coil piece 42 in a manner illustrated in FIG. 14 may be manufactured by bending of a part of a thin coil piece.

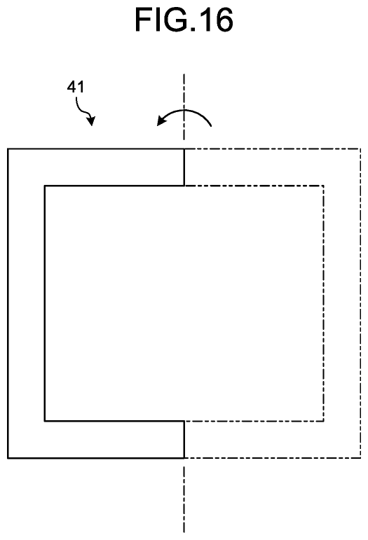

FIG. 16 is a view schematically illustrating a manufacturing method of the first coil piece 41 illustrated in FIG. 8. As illustrated in FIG. 16, the first coil piece 41 in a manner illustrated in FIG. 8 may be manufactured by folding of a thin rectangular annular coil piece in half.

In the above-described embodiment, each of the end portions 520 includes the first portion 521 and the second portion 522, and the thickness D2 of the second portion 522 is thinner than the thickness D1 of the first portion 521. An end portion 520 may include a first portion 521 and a second portion 522, and a cross-sectional area of the second portion 522 may be smaller than a cross-sectional area of the first portion 521. In this case, a thickness D1 of the first portion 521 and a thickness D2 of the second portion 522 may be the same, and the cross-sectional area of the second portion 522 may be smaller than the cross-sectional area of the first portion 521.

In the above-described embodiment, the rotor 3 is arranged on the inner side (inner peripheral side) of the stator core 4, and the motor 1 is an inner rotor-side motor. The rotor 3 only needs to be arranged at a position facing the stator core 4. A motor 1 may be an outer rotor-type motor in which a rotor 3 is arranged on an outer peripheral side of a stator core 4, a dual rotor-type motor in which rotors 3 are arranged on both an inner peripheral side and an outer peripheral side of a stator core 4, or an axial gap-type motor in which a rotor 3 is arranged on a side in an axial direction of a stator core 4.

Note that it is assumed in the above-described embodiment that the motor 1 is a segment-type switched reluctance motor. A motor 1 may be a switched reluctance motor provided with pole teeth, a synchronous reluctance motor, a flux switching motor, a permanent magnet motor, an induction motor, an axial gap motor, or a linear actuator.

It is assumed in the above-described embodiment that the motor 1 is a three-phase motor. A motor 1 may be a four-phase motor. In this case, when the number of poles of a rotor is P, the number of slots of a stator core is S, and a natural number is N,
a condition of
P=5×N, and
S=8×N
is satisfied.

### REFERENCE SIGNS LIST

1 MOTOR
2 STATOR
3 ROTOR
4 STATOR CORE
4A FIRST END SURFACE
4B SECOND END SURFACE
4S INNER PERIPHERAL SURFACE
4T OUTER PERIPHERAL SURFACE
5 COIL
5U U-PHASE COIL
5V V-PHASE COIL
5W W-PHASE COIL
6 ROTOR HOLDER
7 ROTOR CORE PIECE
8 SHAFT
9 SLOT
9A OPENING PORTION
9B OPENING PORTION
9M OPENING PORTION
10 TOOTH
10A END SURFACE
10B END SURFACE
11 OPENING
20 SEGMENT CONDUCTOR
20U SEGMENT CONDUCTOR
20V SEGMENT CONDUCTOR
20W SEGMENT CONDUCTOR
31 COIL SET
32 COIL SET
33 COIL SET
41 FIRST COIL PIECE
42 SECOND COIL PIECE
51 COIL CENTER PORTION
52 COIL END PORTION
91 FIRST SLOT
91A INNER SURFACE
92 SECOND SLOT
92A INNER SURFACE
93 THIRD SLOT
93A INNER SURFACE
94 FOURTH SLOT
94A INNER SURFACE
101 FIRST TOOTH
102 SECOND TOOTH
103 THIRD TOOTH
411 CENTER PORTION
412 END PORTION
412A FIRST END PORTION
412B SECOND END PORTION
412C THIRD END PORTION
412D FIRST BENT PORTION
412E SECOND BENT PORTION
421 CENTER PORTION
422 END PORTION
422A FOURTH END PORTION
422B FIFTH END PORTION
510 CENTER PORTION
520 END PORTION
521 FIRST PORTION
522 SECOND PORTION
AX ROTATION AXIS
D1 THICKNESS
D2 THICKNESS
Ic COIL PITCH
Ip POLE PITCH
R1 SIZE
R2 SIZE
R3 SIZE
RS OBJECT

1. A coil comprising:
a center portion arranged in a slot of a stator core; and
an end portion protruding in an axial direction from the stator core, wherein
the end portion has a first portion, and a second portion thinner than a thickness of the first portion.

2. The coil according to claim 1, wherein
a cross-sectional area of the first portion is larger than a cross-sectional area of the second portion.

3. The coil according to claim 1, wherein
a thickness of the center portion is larger than the thickness of the second portion.

4. The coil according to claim 1, wherein
a thickness of the center portion is equal to the thickness of the first portion.

5. The coil according to claim 1, wherein
a cross-sectional area of the center portion is equal to a cross-sectional area of the first portion.

6. A stator comprising:
a stator core; and
the coil according to claim 1.

7. The stator according to claim 6, wherein
the coil includes a first-phase coil, a second-phase coil, and a third-phase coil,
a coil set of the first-phase coil and the second-phase coil is formed by an arrangement of a part of the second-phase coil between parts of the first-phase coil and an arrangement of a part of the first-phase coil between parts of the second-phase coil,
a coil set of the second-phase coil and the third-phase coil is formed by an arrangement of a part of the third-phase coil between parts of the second-phase coil and an arrangement of a part of the second-phase coil between parts of the third-phase coil,
a coil set of the third-phase coil and the first-phase coil is formed by an arrangement of a part of the first-phase coil between parts of the third-phase coil and an arrangement of a part of the third-phase coil between parts of the first-phase coil, and
in a coil end portion, a second portion of the first-phase coil and a second portion of the second-phase coil are alternately arranged in a radial direction, the second portion of the second-phase coil and a second portion of the third-phase coil are alternately arranged in the radial direction, and the second portion of the third-phase coil and the second portion of the first-phase coil are alternately arranged in the radial direction.

8. The stator according to claim 6, wherein
the stator core has a tooth arranged between slots adjacent to each other, and
the coil is arranged around the tooth at a pitch of two slots.

9. A motor comprising:
the stator according to claim 6; and
a rotor facing the stator core, wherein
when the number of poles of the rotor is P, the number of slots of the stator core is S, and a natural number is N,
a condition of
P=7×N, and
S=12×N
is satisfied.
